(19) United States
(12) Patent Application Publication
(10) Pub. No.: US 2022/0361474 A1
(43) Pub. Date: Nov. 17, 2022

(54) ROW CROP WEED KILLER APPARATUS

(71) Applicant: Kyle H. Beyea, Gothenburg, NE (US)

(72) Inventor: Kyle H. Beyea, Gothenburg, NE (US)

(21) Appl. No.: 17/739,580

(22) Filed: May 9, 2022

Related U.S. Application Data
(60) Provisional application No. 63/188,147, filed on May 13, 2021.
(60) Provisional application No. 63/187,549, filed on May 12, 2021.

(51) Int. Cl. A01M 21/04

(52) U.S. Cl. CPC A01M 21/04

(57) ABSTRACT

A row crop weed killer apparatus which is moved through a row crop. The row crop weed killer apparatus includes a weed destroyer device between a plurality of crop shields to kill weeds while preventing harm to rows of crops.

### CROSS REFERERNCE TO RELATED APPLICATIONS

The present application claims the benefit under 35 U.S.C. § 119(e) of U.S. Provisional Application Ser. No. 63/187,549 filed May 12, 2021, entitled ROW CROP WEED KILLER APPARATUS and U.S. Provisional Application Ser. No. 63/188,147 filed May 13, 2021, entitled ROW CROP WEED KILLER APPARATUS. Said U.S. Provisional Application Ser. No. 63/187,549 filed May 12, 2021, entitled ROW CROP WEED KILLER APPARATUS and U.S. Provisional Application Ser. No. 63/188,147 filed May 13, 2021, entitled ROW CROP WEED KILLER APPARATUS are herein incorporated by reference in their entireties.

### FIELD

The present application is generally directed to weed maintenance, and more particularly, to a row crop weed killer apparatus.

### BACKGROUND

Crops such as soybeans, dry beans, field peas, sugar beets, potatoes, lentils, etc., are planted in spaced-apart rows. The spacing of the rows may be 16″, 22″, 28″, or 30″. Usually, shortly after the crop is planted, the ground between the rows is sprayed with an herbicide to prevent the growth of weeds between the rows. However, post-emergence weeds may begin to grow between the rows. It is difficult to kill the weeds between the rows since the canopies of the crop in adjacent rows have spread outwardly over the ground between the rows. The overhang of the canopies shields the ground there below, thereby making it difficult to kill the weeds.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

Accordingly, an agricultural row crop weed killer apparatus for killing weeds between first, second, and third crop rows in a field as the weed killer apparatus is moved through the field by a vehicle is disclosed. The weed killer apparatus includes a lift frame having a forward end, a rearward end, a first end and a second end. The lift frame may be mounted to the vehicle via a lift hitch of the vehicle with the lift frame extending rearwardly from the vehicle, or may be a lift frame coupled to the vehicle via a front mount, however, the primary description of the concept will be based upon a rear mount of the apparatus to the vehicle.

The lift frame is moveable between raised and lowered positions. The lift frame may include first and second frame members which extend rearwardly from the forward end of the lift frame in a horizontally spaced-apart manner. The lift frame also includes a transversely extending front frame member, having first and second ends, and a transversely extending rear frame member having first and second ends. The front and rear frame members are horizontally spaced-apart.

The apparatus of this invention includes upstanding first, second, third and fourth crop shields, each of which have a lower end, an upper end, a forward end, a rearward end, an inner side and an outer side. The first and second crop shields are secured to the lift frame intermediate the first and second ends of the first and second frame members of the lift frame and are positioned below the lift frame. The first and second crop shields are selectively moveable towards one another and selectively moveable away from one another. The third crop shield is secured to the lift frame at the first end of the lift frame and is positioned below the lift frame. The third crop shield is selectively moveable towards the first crop shield and is selectively moveable away from the first crop shield. The fourth crop shield is secured to the lift frame at the second end of the lift frame and is positioned below the lift frame. The fourth crop shield is selectively moveable towards the second crop shield and is selectively moveable away from the second crop shield.

The row crop weed killer apparatus may include a weed destroyer device, such as a burner (such as a gas burner) or an electrode between rows of crops, the rows of crops protected by the crop shields. The weed destroyer device may deliver a flame to the weeds and destroy the weed between rows of crops protected by the crop shields. Alternatively, the weed destroyer device may include an electrode configured to apply an electrical current to the weeds and destroy the weeds.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1 is a top view of the row crop sprayer of U.S. Pat. No. 10,602,733 B1 which is being pulled through a crop row field by a vehicle such as a tractor, ATV, etc.;

FIG. 2 is a side view of the row crop sprayer of U.S. Pat. No. 10,602,733 B1 being pulled through a crop row field;

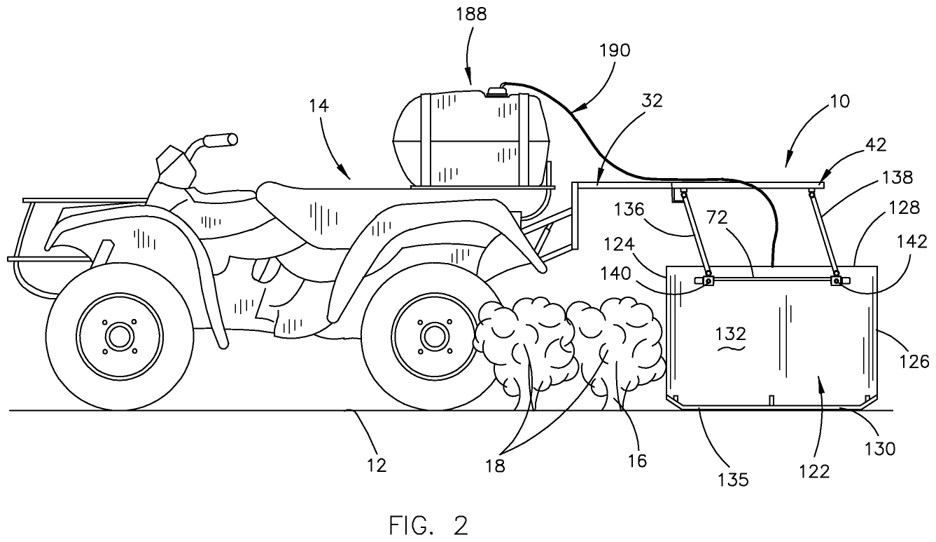

FIG. 3 is a partial view of the row crop sprayer of U.S. Pat. No. 10,602,733 B1;

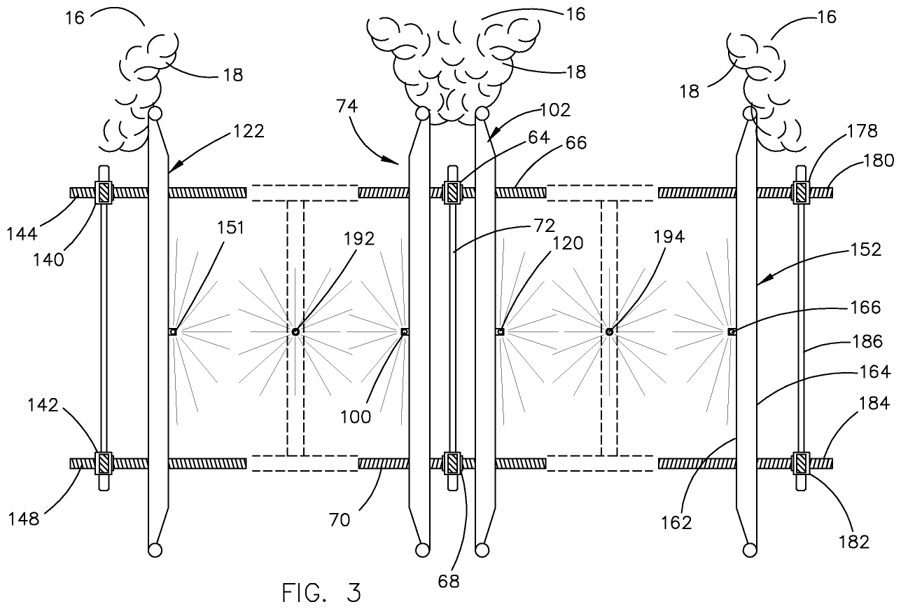

FIG. 4 is a partial perspective view of the row crop sprayer of U.S. Pat. No. 10,602,733 B1;

FIG. 5 is a partial perspective view of the row crop sprayer of U.S. Pat. No. 10,602,733 B1;

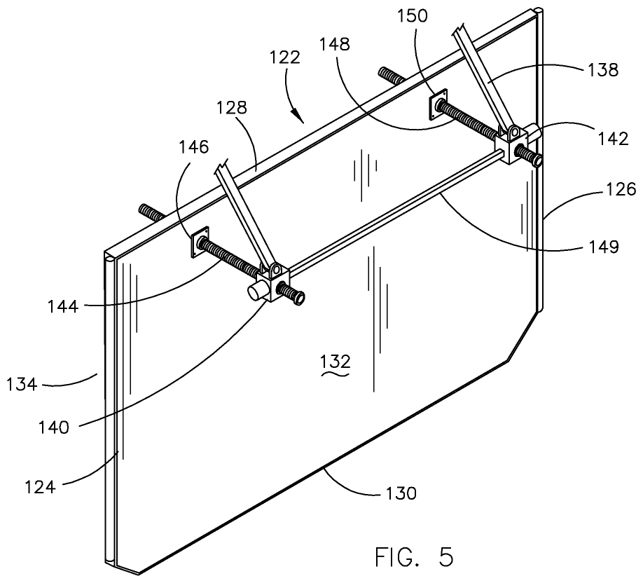

FIG. 6 is a partial side view of one of the crop shields of the row crop sprayer of U.S. Pat. No. 10,602,733 B1 with the broken lines illustrating the crop shield being in an elevated position;

FIG. 7 is a top view of a row crop weed killer apparatus of the present invention;

FIG. 8 is an exploded view of a weed destroyer device as shown in FIG. 7;

FIG. 9 is another exploded view of a weed destroyer device as shown in FIG. 7;

FIG. 10 is a top view of a row crop weed killer apparatus in accordance with an alternative embodiment of the present invention;

FIG. 11 is an exploded view of a weed destroyer device as shown in FIG. 10; and

FIG. 12 depicts a front mounted row crop weed killer apparatus of the present invention.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

The disclosure of U.S. Pat. No. 10,602,733 B1, which issued to Applicant on Mar. 31, 2020, is incorporated herein by reference thereto to complete this disclosure if necessary. The present invention is based on the row crop sprayer of U.S. Pat. No. 10,602,733 B1. In the ‘733 patent, sprayers are disclosed for spraying herbicide onto the weeds between the crop rows. Applicant's present application discloses a weed destroyer device which kills weeds and reduces the use of chemicals.

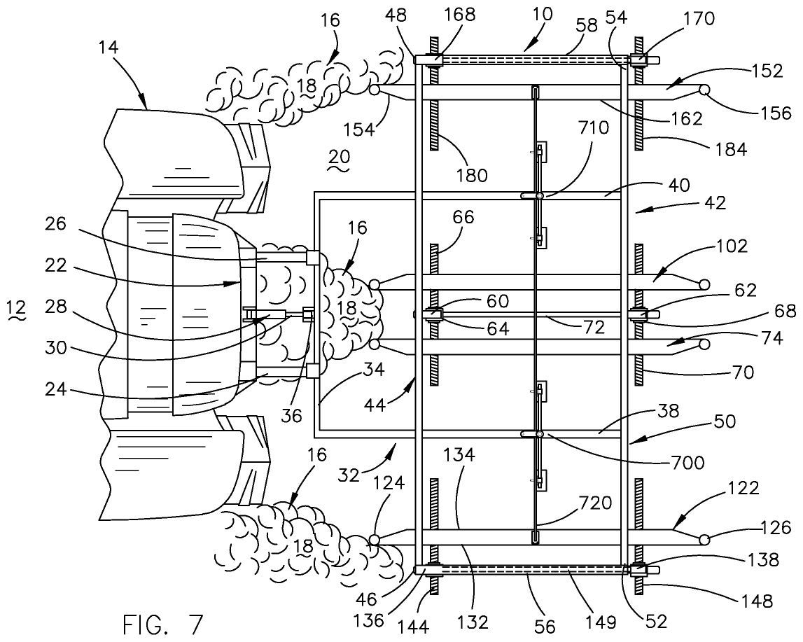

Therefore, the drawings of U.S. Pat. No. 10,602,733 B1 will be used herein as well as some of the description thereof. At the end of the disclosure, FIGS. 7-12 will be identified which illustrate Applicant's present invention.

The row crop sprayer of the ‘733 patent is designated by the reference numeral 10. The sprayer 10 is configured to be parallel through the crop row field 12 by a vehicle such as an ATV or tractor 14. The field 12 has a plurality of crop rows 16 wherein the plants or crops therein have canopies 18 which hang over the ground 20 between the adjacent crop rows 16.

The vehicle 14 has a three-point hitch 22 of conventional design positioned at the rear of the pivotal left arms 24 and 26 which extend rearwardly from the vehicle 14. Hitch 22 includes a pair of pivotal lift arms 24 and 26 which extend rearwardly from the vehicle 14. Hitch 22 also includes a hydraulic electrical lift cylinder 28. The rearward end of the cylinder rod 30 of lift cylinder 28 is connected to the forward end of a lift frame 32. Lift frame 32 includes a transversely extending front frame member 34 to which the cylinder rod 30 of lift cylinder 28 is connected at 36. Lift frame 32 has an elongated frame member 38 extending rearwardly from one end of frame member 34. Lift frame 32 also has an elongated frame member 40 extending rearwardly from the other end thereof. Thus, when hydraulic cylinder 28 is extended, lift frame 32 will be raised. When lift cylinder 28 is retracted, lift frame 32 will be lowered.

The numeral 42 refers to a crop shield lift frame means which is secured to lift frame 32 so as to be transversely disposed with respect to lift frame 32. Crop shield lift frame means 42 includes an elongated front frame 44 member having ends 46 and 48. Crop shield lift frame means 42 also includes an elongated rear frame member 50 having ends 52 and 54. A frame member 56 is secured to ends 46 and 52 of frame members 44 and 50 respectively and extends therebetween. A frame member 58 is secured to ends 48 and 54 of frame members 44 and 50 respectively and extends therebetween.

A pair of elongated parallel arms 60 and 62 have their upper ends pivotally secured to frame members 44 and 50 respectively and extend downwardly and rearwardly therefrom. An electrically driven Acme screw motor 64 is pivotally secured to the lower end of arm 60 and has a rotatable twin lead screw 66 extending therethrough with the threads thereof on opposite sides of the motor being on opposite sides of the motor being opposite. An electrically driven Acme screw motor 68 is pivotally secured to the lower end of arm 62 and has a rotatable twin lead screw 70 extending therethrough and therefrom. A stabilizer rod or shaft 72 is secured to the motors 64 and 68 and extends therebetween.

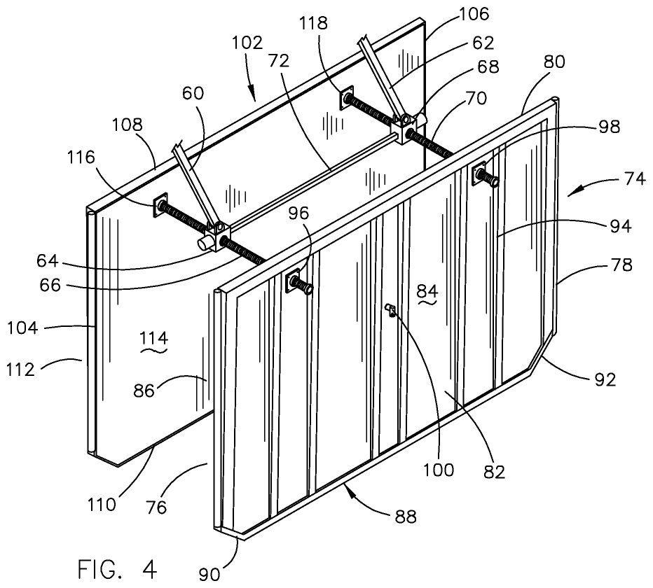

The numeral 74 refers to a first upstanding crop shield having a forward end 76, a rearward end 78, an upper end 80, a lower end 82, an outer side 84 and an inner side 86. The lower end 82 of crop shield 74 has a skid member 88 therein which has an upwardly tapered or beveled portion 90 at its forward end and a tapered or beveled portion 92 at its rearward end. The outer side 84 of crop shield 74 has stiffening member 94 thereon. Crop shield 74 has a pair of Acme adjustment drive members 96 and 98 positioned therein at its upper end 80 as seen in FIG. 4. The Acme adjustment drive members 96 and 98 threadably receive one end of the twin lead screws 66 and 70 respectively. When the screws 66 and 70 are rotated in a first direction by the motors 64 and 68 respectively, the crop shield 74 will be moved inwardly. When the screws 66 and 70 are rotated in a second direction by the motors 64 and 68 respectively, the crop shield 74 will be moved outwardly.

Crop shield 74 has a spray nozzle 100 at its outer side which is designed to spray liquid herbicide downwardly and outwardly onto the grout at one side of the crop row.

The numeral 102 refers to a second upstanding crop shield having a forward end 104, a rearward end 106, an upper end 108, a lower end 110, an outer side 112 and an inner side 114. The inner side 114 of crop shield 102 has a pair of Acme adjustable drive members 116 and 118 mounted thereon which receive the ends of the two lead screws 66 and 70 respectively. Thus, when the motors 64 and 68 rotate the screws 66 and 70 in one direction, crop shields 74 and 102 will be moved towards one another. When the motors 64 and 68 rotate the screws 66 and 70 in an opposite direction, the crop shields 74 and 102 will be moved away from one another. Crop shield 102 has a spray nozzle 120 at its outer side.

The numeral 122 refers to a third upstanding crop shield having a forward end 124, a rearward end 126, an upper end 128, a lower end 130, an outer side 132 and an inner side 134. A spray nozzle 135 is positioned at the inner side 134 of crop shield 122. A pair of parallel arms 136 and 138 have their upper ends pivotally secured to frame members 44 and 50 and extend downwardly and rearwardly therefrom.

An Acme screw motor 140 is pivotally secured to the lower end of arm 136 and an Acme screw motor 142 is pivotally secured to the lower end of arm 138. Motor 140 has a threaded and rotatable screw 144 extending therethrough and therefrom. Screw 144 extends through an Acme adjustable drive member 146 which is mounted on crop shield 122. Motor 142 has a threaded and rotatable screw 148 extending therethrough and therefrom. Screw 148 extends through an Acme adjustable drive member 150 which is mounted on crop shield 122. When the motors 140 and 142 rotate the screws 144 and 148 in a first direction, the crop shield 122 will be moved outwardly. When the motors 140 and 142 rotate the screws 144 and 148 in an opposite direction, the crop shield 122 will be moved inwardly.

The numeral 152 refers to an upstanding fourth crop shield having a forward end 154, a rearward end 156, an upper end 158, a lower end 160, an inner side 162 and an outer side 164. Crop shield 152 has a spray nozzle 166 at its inner side 162.

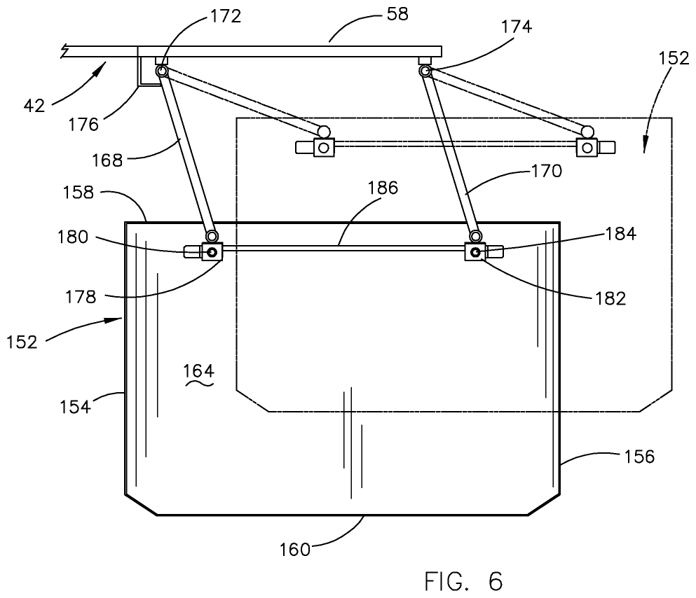

A pair of parallel arms 168 and 170 have their upper ends pivotally secured to frame member 58 at 172 and 174 respectively and extend downwardly and rearwardly therefrom. A stop 176 limits the forward pivotal movement of arm 168 as seen in FIG. 6. An Acme screw motor 178 is secured to the lower end of arm 168 and has a screw 180 rotatably extending therethrough. The inner end of screw 180 extends through an Acme adjustable drive member on crop shield 152. An Acme screw motor 182 is secured to the lower end of arm 170 and has a screw 184 rotatably extending therethrough. The inner end of screw 184 extends through an Acme adjustable drive member on crop shield 152. A rod or shaft 186 is secured to motors 178 and 182 and extends therebetween.

The numeral 188 refers to a liquid storage tank which includes a conventional pump having a liquid discharge hose assembly 190 extending therefrom. Hose assembly 190 is fluidly connected to the spray nozzles 100, 120, 151 and 166. Hose drop lines extend downwardly to spray nozzles 192 and 194.

The row crop sprayer 10 of this invention as will now be described. The forward end of the lift frame 32 is secured to the 3-point hitch 22 of the vehicle 14. The vehicle 14 may be an ATV, tractor or a self-propelled vehicle. The hitch 22 of the vehicle will normally be in its raised travel position until the spraying operation begins. When the lift frame 32 is in an elevated position, the lower ends of the crop shields 74, 102, 122 and 152 will be positioned above the ground to enable the sprayer 10 to be moved from one location to another.

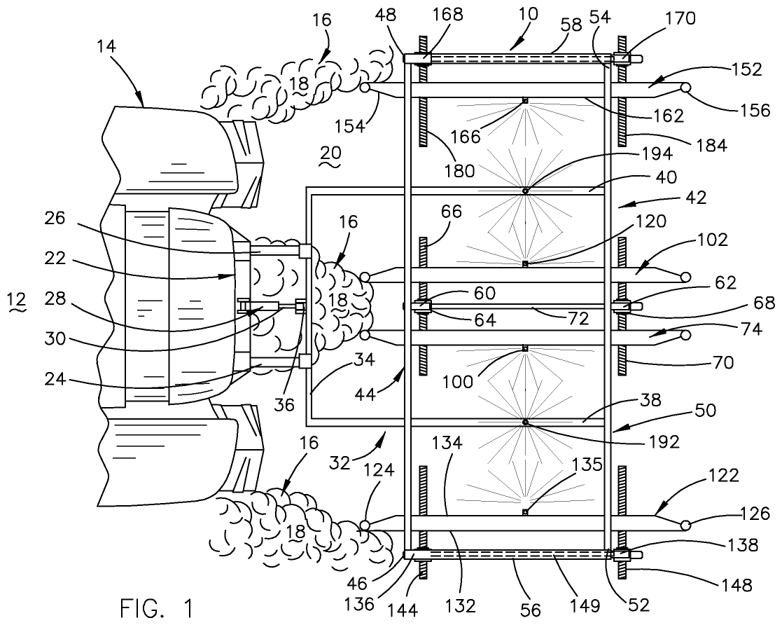

The vehicle 14 will then be positioned with respect to the crop rows 16 so sprayer 10 will be positioned with respect to one end of the three crop row 16 having canopies 18. The vehicle 14 will be moved so that the crop shields 74 and 102 will be aligned with a crop row 16 as seen in FIG. 1. When the sprayer 10 is so positioned, the crop shield 122 will be aligned with a second crop row 16 and the crop shield 152 will be aligned with a third crop row 16 as seen in FIG. 1.

The crop shields 74 and 102 are moveable towards one another or moved away from one another, from the vehicle 14, to compensate for the width of the canopy of that crop row by actuating the screw motors 64 and 68 which causes lateral movement of the crop shields 74 and 102 by way of the two lead screws 66 and 70.

The position of the crop shield 122 is laterally adjusted by the screw motors 140 and 142 by way of the screws 144 and 148 so that the forward end of crop shield 122 is positioned with respect to the canopy 18 of the crop row 16 as seen in FIG. 1. The position of the crop shield 152 is laterally adjusted by the screw motors 178 and 182 so that the forward end of the crop shield 152 is positioned with respect to the canopy 18 of crop row 16 as seen in FIG. 1.

The vehicle is then moved forwardly so that the canopy of the crop row 16 associated with crop shields 74 and 102 is deflected inwardly as the sprayer 10 moves through the field. The inward deflection of the canopy of the crop row associated with the crop shields 74 and 102 exposes more of the ground at either side of that crop row so that the spray nozzles 100, 120, 192 and 194 may spray the herbicide onto the ground closer to the sides of the crop of the crop row 16.

As the vehicle 14 moves through the field, the crop shields 122 and 152 inwardly deflect the canopies of the associated crop rows 16 to expose the ground at the inner sides thereof so that the spray nozzles 135, 166, 192 and 194 may spray the herbicide onto the exposed ground.

Although the drawings illustrate that the sprayer 10 may be used with three crop rows, the components of the sprayer 10 could be used on an elongated tool bar to spray additional crop rows.

Referring to FIG. 7, a top view of a row crop weed killer apparatus of the present invention is shown. The row crop weed killer apparatus of FIG. 7 utilizes the structure of U.S. Pat. No. 10,602,733 B1 except that the spray nozzles have been eliminated and a chemical-free weed destroyer device is employed. In this example, the weed destroyer device 700 may include a gas-fired burner apparatus to enhance the killing of weeds between the crop rows but to eliminate the use of chemicals.

As seen in FIG. 7, a weed destroyer device 700 may be in the form of a gas-fired burner apparatus that may deploy a flame and may destroy weeds between the outer side of the first crop shield 74 and the inner side of the third crop shield 122. A second weed destroyer device 710 may be in the form of a gas-fired burner apparatus and may be mounted between the outer side of the second crop shield 102 and the inner side of the fourth crop shield 152. It is contemplated that each weed destroyer device 700, 710 may connect to a horizontal gas delivery pipe 720 which is connected to a source of gas, such as a gas tank. The source of gas may be mounted to the vehicle or the lift frame

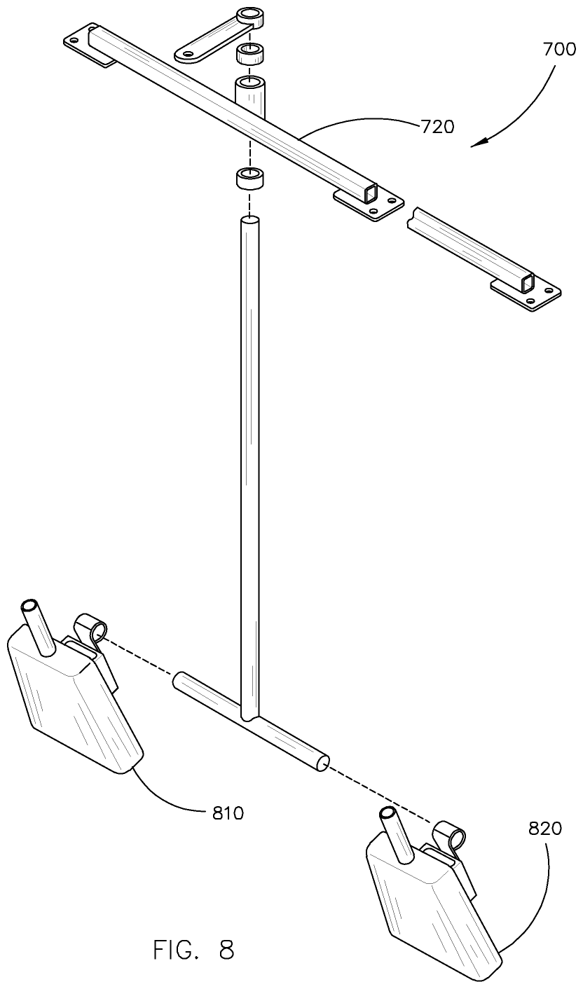

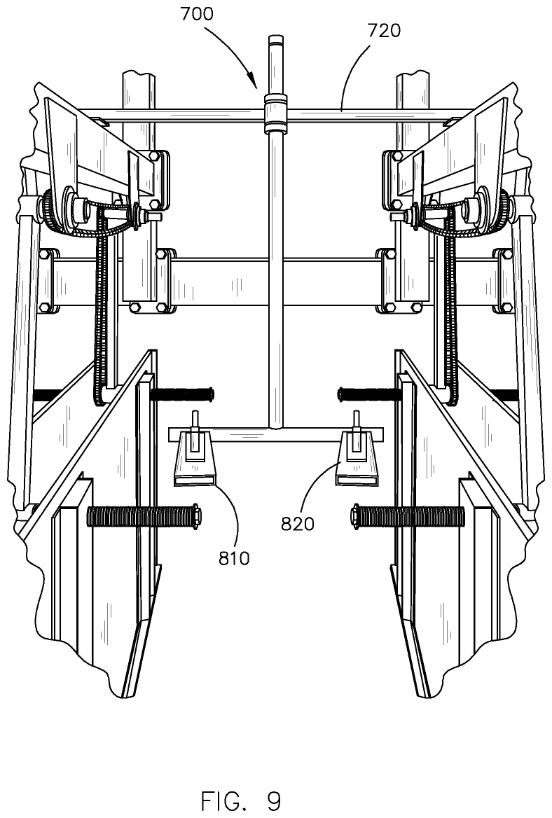

Referring to FIGS. 8-9, exploded views of a weed destroyer device 700 as shown in FIG. 7 are presented. Weed destroyer device 700 may include a gas-fired burner apparatus which may include a drop-down pipe which may connect each gas-fired burner 810, 820 to the horizontal gas delivery pipe 720. The drop-down pipe may allow the flame of gas-fired burner 800, 810 to be in proximity with the weeds. As shown in FIGS. 8-9, a a distribution pipe may connect to the drop-down pipe whereby multiple gas-fired burners 810, 820 may be placed between rows of cops. This may be useful when row widths may be larger, such as 24 inches or 30 inches. It is contemplated that the source of gas may be propane or the like. It is contemplated that the gas-fired burners 810, 820 may be of conventional design and readily available.

It is contemplated that crop shields 74, 102, 122, 152 may be formed of plastic and may further include a ceramic blanket and metal shield. The metal shield may provide abrasion resistance for the ceramic blanket. It is contemplated that the metal shield and ceramic blanket will improve wear due to exposure to flames from weed destroyer devices 700, 710 in a form of gas-fired burners.

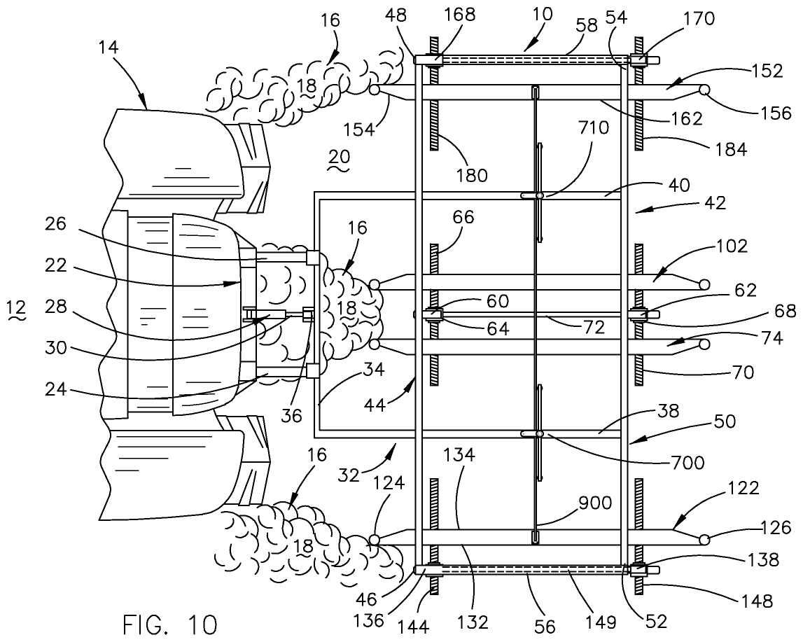

Referring to FIG. 10, a top view of a row crop weed killer apparatus in accordance with an alternative embodiment of the present invention is shown. The row crop weed killer apparatus of FIG. 10 utilizes the structure of U.S. Pat. No. 10,602,733 B1 except that the spray nozzles have been eliminated and a chemical-free weed destroyer device is employed. In this example, the weed destroyer device 700, 710 may include an electrode to enhance the killing of weeds between the crop rows but to eliminate the use of chemicals.

As seen in FIG. 10, a weed destroyer device 700 may be in the form of an electrode that may deploy an electrical current configured to destroy weeds between the outer side of the first crop shield 74 and the inner side of the third crop shield 122. A second weed destroyer device 710 may be in the form of an electrode and may be mounted between the outer side of the second crop shield 102 and the inner side of the fourth crop shield 152. It is contemplated that each weed destroyer device 700, 710 may connect to an electrical power distribution cable 900 which is connected to a source of electricity, such as an electrical generator. The source of electricity, such as a gas-powered electrical generator, may be mounted to the vehicle or the lift frame 32. It is further contemplated that a drop-down cable may connect each weed destroyer device 700, 710, to the electrical power distribution cable 900. The drop-down cable may allow the electrode to be in proximity with the weeds. The electrical power distribution cable 900 and the drop-down cable may be enclosed with a rigid barrier, such as a pipe. It is contemplated that the electrode may provide thermal weed control and may provide 30 kilovolt-amperes ana between 5000-12000 Volts.

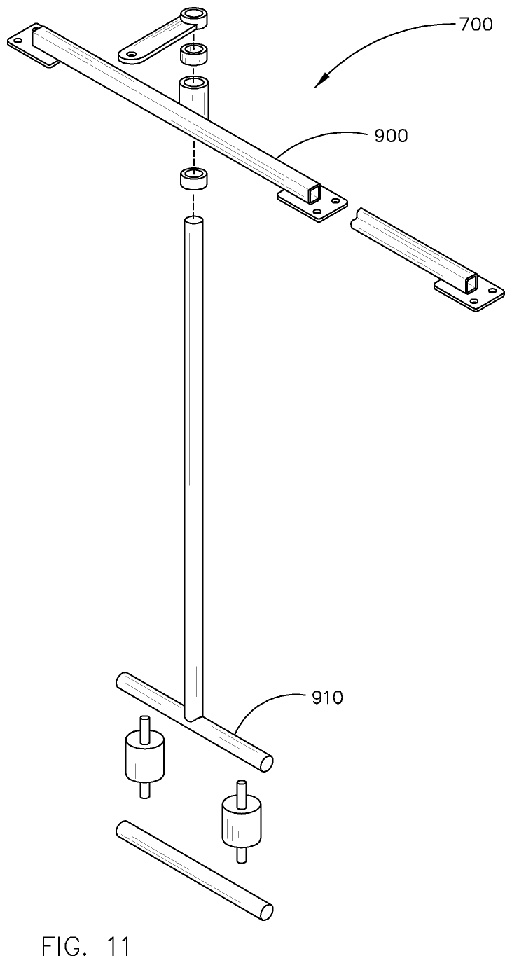

Referring to FIG. 11, an exploded view of a weed destroyer device 700 as shown in FIG. 10 is presented. The weed destroyer device 700 may include an electrode 910. It is contemplated that the width of the electrode may be sized appropriately based upon the row width that is used. The electrode 910 may be of conventional design and are readily available.

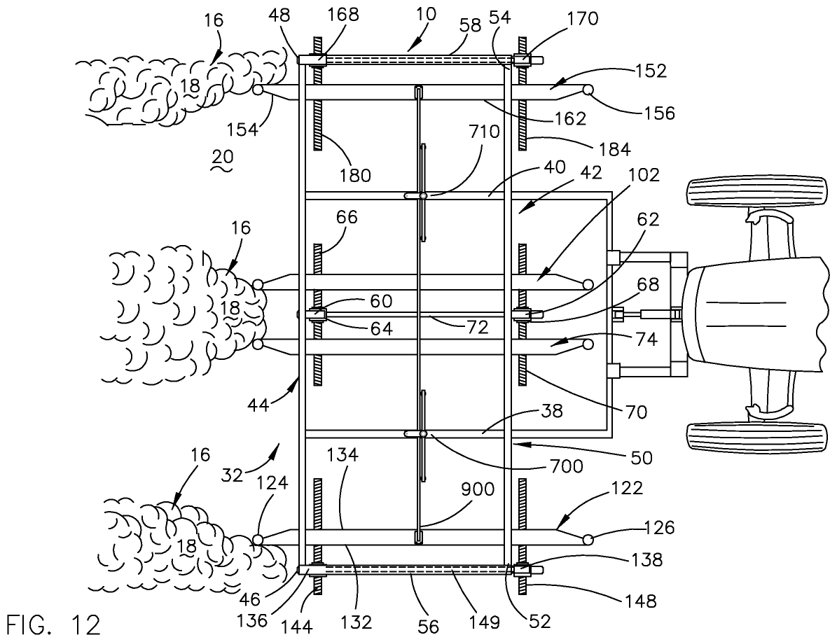

It is contemplated that the row crop weed killer apparatus may be a front mounted apparatus. For example, the row crop weed killer apparatus may be mounted to the front 3-point of a tractor as shown in FIG. 12. The front mounted row crop weed killer apparatus may be substantially similar as the rear mounted row crop weed killer apparatus, however, the row units may be pushed instead of pulled. For example, as shown in FIG. 7 and FIG. 10, the forward end of the lift frame 32 may be secured to the lift hitch of the vehicle with the lift frame extending rearwardly from the vehicle. As shown in FIG. 12, it is contemplated that the rear end of the lift frame 32 may be secured to the front lift hitch of the vehicle with the lift frame extending forwardly from the vehicle.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

what is claimed is:

1. An agricultural row crop weed killer apparatus for killing the weeds between first, second and third crop rows in a field as the weed killer apparatus is moved through the field by a vehicle having a lift hitch, comprising:
a lift frame means having a forward end, a rearward end, a first end and a second end;
said forward end of said lift frame means being secured to the lift hitch of the vehicle with said lift frame means extending rearwardly from the vehicle;
said lift frame means being movable between raised and lowered positions by the lift hitch;
an upstanding first crop shield having a lower end, an upper end, a forward end, a rearward end, an inner side and an outer side;
an upstanding second crop shield having a lower end, an upper end, a forward end, a rearward end, an inner side and an outer side;
an upstanding third crop shield having a lower end, an upper end, a forward end, a rearward end, an inner side and an outer side;
an upstanding fourth crop shield having a lower end, an upper end, a forward end, a rearward end, an inner side and an outer side;
said first and second crop shields being secured to said lift frame means intermediate said first and second ends of said lift frame means and positioned below said lift frame means;
said first and second crop shields being selectively moveable towards one another and being selectively moveable away from one another;
said third crop shield being secured to said lift frame means at said first end of said lift frame means and being positioned below said lift frame means;
said third crop shield being selectively movable towards said first crop shield and being selectively movable away from said first crop shield;
said fourth crop shield being secured to said lift frame means at said second end of said lift frame means and being positioned below said lift frame means;
said fourth crop shield being selectively movable towards said second crop shield and being selectively movable away from said second crop shield;
said first and second crop shields being spaced-apart a distance which is less than the width of the canopy of the first crop row;
said forward ends of said first and second crop shields engaging and narrowing the canopy of the first crop row as the vehicle moves the apparatus through the field whereby the canopy of the first crop row will pass rearwardly between said first and second crop shields;
said forward end of said third crop shield engaging the inner side of the canopy of the second crop row as the vehicle moves the apparatus through the field whereby the inner side of the canopy of the second crop row will be deflected outwardly and then passed rearwardly along said outer side of said third crop shield;
said forward end of said fourth crop shield engaging the inner side of the canopy of the third crop row as the vehicle moves the apparatus through the field whereby the inner side of the canopy of the third crop row will be deflected outwardly and then passed rearwardly along said outer side of said fourth crop shield;
a first weed destroyer device mounted between said outer side of said first crop shield and said inner side of the third crop shield;
said first weed destroyer device being configured to destroy weeds between said outer side of said first crop shield and said inner side of the third crop shield;
a second weed destroyer mounted between said outer side of said second crop shield and said inner side of the fourth crop shield;
said second weed destroyer being configured to destroy weeds between said outer side of said second crop shield and said inner side of the fourth crop shield.

2. The agricultural row crop weed killer apparatus as claimed in claim 1, where the first weed killer is at least one of a gas-fired burner or an electrode.

3. The agricultural row crop weed killer apparatus as claimed in claim 1, wherein the weed destroyer is coupled to at least one of a gas tank or an electrical generator.

4. An agricultural row crop weed killer apparatus for killing the weeds between first, second and third crop rows in a field as the weed killer apparatus is moved through the field by a vehicle having a lift hitch, comprising:
a lift frame means having a forward end, a rearward end, a first end and a second end;
said rear end of said lift frame means being secured to the lift hitch of the vehicle with said lift frame means extending forwardly from the vehicle;
said lift frame means being movable between raised and lowered positions by the lift hitch;
an upstanding first crop shield having a lower end, an upper end, a forward end, a rearward end, an inner side and an outer side;
an upstanding second crop shield having a lower end, an upper end, a forward end, a rearward end, an inner side and an outer side;
an upstanding third crop shield having a lower end, an upper end, a forward end, a rearward end, an inner side and an outer side;
an upstanding fourth crop shield having a lower end, an upper end, a forward end, a rearward end, an inner side and an outer side;
said first and second crop shields being secured to said lift frame means intermediate said first and second ends of said lift frame means and positioned below said lift frame means;
said first and second crop shields being selectively moveable towards one another and being selectively moveable away from one another;
said third crop shield being secured to said lift frame means at said first end of said lift frame means and being positioned below said lift frame means;
said third crop shield being selectively movable towards said first crop shield and being selectively movable away from said first crop shield;
said fourth crop shield being secured to said lift frame means at said second end of said lift frame means and being positioned below said lift frame means;
said fourth crop shield being selectively movable towards said second crop shield and being selectively movable away from said second crop shield;
said first and second crop shields being spaced-apart a distance which is less than the width of the canopy of the first crop row;
said forward ends of said first and second crop shields engaging and narrowing the canopy of the first crop row as the vehicle moves the apparatus through the field whereby the canopy of the first crop row will pass rearwardly between said first and second crop shields;
said forward end of said third crop shield engaging the inner side of the canopy of the second crop row as the vehicle moves the apparatus through the field whereby the inner side of the canopy of the second crop row will be deflected outwardly and then passed rearwardly along said outer side of said third crop shield;
said forward end of said fourth crop shield engaging the inner side of the canopy of the third crop row as the vehicle moves the apparatus through the field whereby the inner side of the canopy of the third crop row will be deflected outwardly and then passed rearwardly along said outer side of said fourth crop shield;
a first weed destroyer device mounted between said outer side of said first crop shield and said inner side of the third crop shield;
said first weed destroyer device being configured to destroy weeds between said outer side of said first crop shield and said inner side of the third crop shield;
a second weed destroyer mounted between said outer side of said second crop shield and said inner side of the fourth crop shield;
said second weed destroyer being configured to destroy weeds between said outer side of said second crop shield and said inner side of the fourth crop shield.

5. The agricultural row crop weed killer apparatus as claimed in claim 4, where the first weed destroyer device includes at least one of a gas-fired burner or an electrode.

6. The agricultural row crop weed killer apparatus as claimed in claim 4, wherein the first weed destroyer device is coupled to at least one of a gas tank or an electrical generator.
